(19) United States
(12) Patent Application Publication
(10) Pub. No.: US 2018/0239042 A1
(43) Pub. Date: Aug. 23, 2018

(54) LOW-POWER SYNCHRONOUS SERIAL INTERFACE FOR A GEOPHYSICAL SENSOR ARRAY

(71) Applicant: PGS Geophysical AS, Oslo (NO)

(72) Inventor: Zachary WARE, Woodlands, TX (US)

(73) Assignee: PGS Geophysical AS, Oslo (NO)

(21) Appl. No.: 15/879,123

(22) Filed: Jan. 24, 2018

Related U.S. Application Data
(60) Provisional application No. 62/462,713, filed on Feb. 23, 2017.

(51) Int. Cl. G01V 1/38

(52) U.S. Cl. CPC G01V 1/3808; H04L 67/12

(57) ABSTRACT

The present disclosure provides a low-power synchronous serial interface for a geophysical sensor array that advantageously reduces the time required to diagnose streamer communications problems and further reduces power requirements for streamers. In one embodiment, the geophysical sensor array includes a plurality of towed streamers, each streamer including a series of sensor nodes distributed thereon. Each sensor node includes at least a first transmitter interface that sends a first transmitted data signal to a first adjacent node and at least a first receiver interface that receives a first received data signal from the first adjacent node. The data signals communicated between said interfaces may use low-voltage differential signaling and may be differential Manchester encoded. Other embodiments, aspects and features are also disclosed.

### CROSS-REFERENCE TO RELATED APPLICATIONS

The present application claims priority to U.S. Provisional Application No. 62/462,713, filed Feb. 23, 2017, the entire disclosure of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Marine seismic surveying systems are used to acquire seismic data from Earth formations below the bottom of a body of water, such as a lake or the ocean. Marine seismic surveying systems typically include a seismic vessel having onboard navigation, seismic energy source control, and data recording equipment. The seismic vessel is typically configured to tow one or more streamers through the water. The one or more streamers are in the most general sense long cables that have geophysical sensors disposed at spaced apart positions along the length of the cables. A typical streamer may extend behind the seismic vessel for several kilometers.

At selected times, the seismic energy source control equipment causes one or more seismic energy sources (which may be towed in the water by the seismic vessel or by another vessel) to actuate. Signals produced by various sensors on the one or more streamers are ultimately conducted to the recording equipment, where a record with respect to time is made of the signals produced by each sensor (or groups of such sensors). The recorded signals are later interpreted to infer the structure and composition of the Earth formations below the bottom of the body of water. Knowledge of the structure and composition of the Earth formations is highly valuable for the efficient exploration and recovery of offshore petroleum resources.

### BRIEF DESCRIPTION OF THE DRAWINGS

FIG. 1 shows an exemplary implementation of a marine geophysical survey system with towed streamers in accordance with an embodiment of the invention.

FIG. 2 illustrates telemetry for a geophysical sensor array having a single tier network structure in accordance with an embodiment of the invention.

FIG. 3 illustrates a clock signal, a data signal, and Differential Manchester encoding of the data signal in accordance with an embodiment of the invention.

FIG. 4 illustrates a low-power synchronous serial interface for a, receiving device that performs clock and data recovery for any receiving pair interface in accordance with an embodiment of the invention.

FIG. 5A illustrates an exemplary implementation of a Hogge phase detector circuit.

FIG. 5B shows a modified Hogge phase detector circuit as described using HDL before synthesis in accordance with an embodiment of the invention.

FIG. 6 illustrates telemetry for a geophysical sensor array having a multi-tier network structure in accordance with an embodiment of the invention.

These drawings illustrate certain aspects of some of the embodiments of the present invention and should not be used to limit or define the invention.

### DETAILED DESCRIPTION

Marine geophysical data acquisition may be performed using geophysical sensors spaced apart on towed streamers. A very large amount of data is generated by the sensors during the acquisition and needs to be transmitted via sensor network telemetry to the data recording system.

A common previous solution for the sensor network telemetry utilizes comparator circuitry on a printed circuit board (PCB) at each sensor. The comparator circuitry conditions an input signal from the sensor. However, the tolerance of the comparator circuitry varies between PCBs, which makes diagnostics and support difficult. Furthermore, the comparator circuitry generally includes large transformers for each endpoint, which may increase the size of the PCB, the quantity of components on the PCB, or both.

To address these problems, the present disclosure provides a low-power synchronous serial interface for a geophysical sensor array that advantageously reduces the time required to diagnose streamer communications problems and further reduces power requirements for streamers. In an exemplary implementation, the low-power synchronous serial interface includes two-state voltage encoding. Two-state voltage encoding advantageously reduces complexity of debugging and signal conditioning when compared against three-state voltage encoding.

Low-voltage differential signaling (LVDS) may be used as a line driver for the low-power synchronous serial interface. For example, a differential, serial communications protocol, such as LVDS TIA/EIA-644, may be used. LVDS may operate at low power but at a high speed. In some previous approaches, LVDS may be used for communication within a PCB. However, as disclosed herein, LVDS may also be applied to seismic telemetry, such as over twisted-pair cabling, for example.

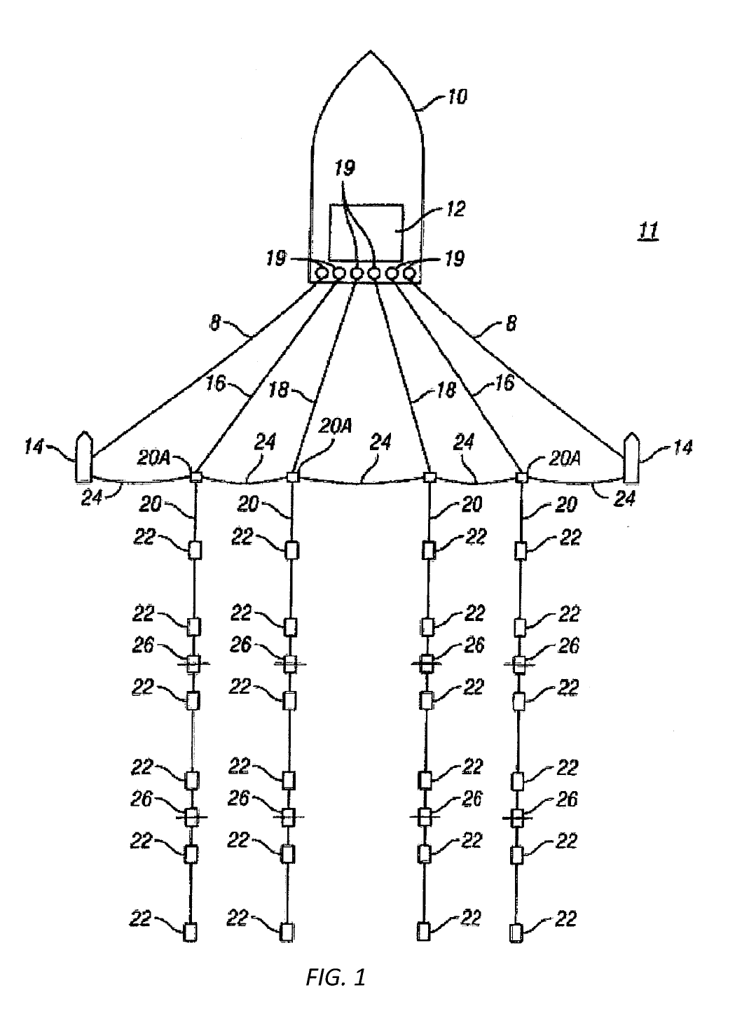

FIG. 1 shows an exemplary implementation of a marine geophysical survey system with towed streamers in accordance with an embodiment of the invention. The marine geophysical survey system may include a vessel 10 that moves along the surface of a body of water 11 such as a lake or the ocean.

The vessel 10 may include thereon certain equipment, shown at 12 and for convenience collectively called a “recording” or “onboard acquisition” system. The onboard acquisition system 12 typically includes a data recording unit 13 for making a record, typically indexed in some direct or indirect way with respect to time, of signals generated by various geophysical sensors in the acquisition system. The onboard acquisition system 12 also typically includes navigation equipment (not shown separately) to determine at any time the position of the vessel 10 and each of a plurality of geophysical sensors 22 disposed at spaced apart locations on streamers 20 towed by the vessel 10. The onboard acquisition system 12 may include devices for selective actuation of a seismic energy source or an array of such sources.

The geophysical sensors 22 may be seismic sensors. In accordance with an embodiment of the invention, each geophysical sensor may be a combination of seismic sensors. For example, each sensor may be a dual sensor including a directional sensor, such as a motion responsive sensor or acceleration sensor, substantially collocated with a non-directional sensor, such as a pressure sensor or pressure time gradient sensor. The geophysical sensors 22 measure seismic energy primarily reflected from various structures in the Earth's subsurface below the bottom of the water 11. The seismic energy originates from a seismic energy source deployed in the water 11. The seismic energy source may be towed in the water 11 by the seismic vessel 10 or by a different vessel.

In the seismic survey system depicted, there are four geophysical sensor streamers 20 towed by the seismic vessel 10. The number of geophysical sensor streamers may be different in other examples; therefore, the number of streamers such as shown in this example is not a limit on the scope of the present invention. In seismic acquisition systems, such as shown in this example, that include a plurality of laterally spaced apart streamers, the streamers 20 are coupled to towing equipment that secures the forward ends of the streamers 20 at selected lateral positions with respect to each other and with respect to the seismic vessel 10.

As shown in this example, the towing equipment may include two paravane tow ropes 8 each coupled to the vessel 10 at one end through a winch 19 or similar spooling device that enables changing the deployed length of each paravane tow rope 8. The distal end of each paravane tow rope 8 is functionally coupled to a paravane 14. The paravanes 14 are each shaped to provide a lateral component of motion to the various towing components deployed in the water 11 when the paravanes 14 are moved through the water 11. The lateral motion component of each paravane 14 is opposed to that of the other paravane 14, and is generally in a direction transverse to the centerline of the vessel 10. The combined lateral motion of the paravanes 14 separates the paravanes 14 from each other until they put into tension one or more spreader ropes or cables 24, functionally coupled end to end between the paravanes 14.

The streamers 20 are each coupled at the axial end thereof nearest the vessel 10 to a respective lead-in cable termination 20A. The lead-in cable terminations 20A are coupled to or are associated with the spreader ropes or cables 24 so as to fix the lateral positions of the streamers 20 with respect to each other and with respect to the vessel 10.

Electrical and/or optical connection between the appropriate components in the onboard acquisition system 12 and, ultimately, the sensors 22 and other circuitry in the ones of the streamers 20 inward of the lateral edges of the system may be made using inner lead-in cables 18, each of which terminates in a respective lead-in cable termination 20A. A lead-in termination 20A is disposed at the vessel end of each streamer 20. Corresponding electrical and/or optical connection between the appropriate components of the onboard acquisition system 12 and the sensors in the laterally outermost streamers 20 may be made through respective lead-in terminations 20A, using outermost lead-in cables 16. Each of the inner lead-in cables 18 and outermost lead-in cables 16 may be deployed by a respective winch 19 or similar spooling device such that the deployed length of each cable 16, 18 may be changed.

The system shown also includes a plurality of lateral force and depth (LFD) control devices 26 cooperatively engaged with each of the streamers 20 at selected positions along each streamer 20. Each LFD control device 26 may include rotatable control surfaces that when moved to a selected rotary orientation with respect to the direction of movement of such surfaces through the water 11 creates a hydrodynamic lift in a selected direction to urge the streamer 20 in any selected direction upward or downward in the water 11 or transverse to the direction of motion of the vessel. Thus, the LFD control devices 26 may be used to maintain the streamers 20 in a selected geometric arrangement. The LFD control devices 26 may be operated by command signals generated in the onboard acquisition system 12 in response to control inputs.

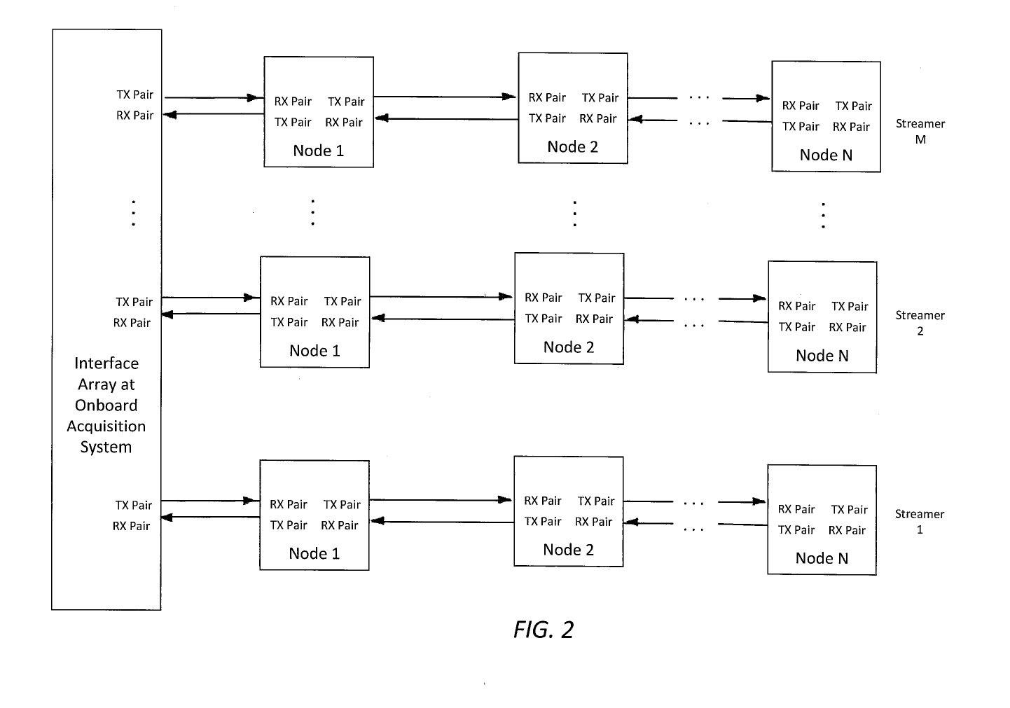

FIG. 2 illustrates telemetry for a geophysical sensor array having a single tier network structure in accordance with an embodiment of the invention. The sensor array may include multiple towed streamers (Streamer 1, Streamer 2, . . . , Streamer M). Each streamer may include a series of sensor nodes (Node 1, Node 2, . . . Node N). The network structure may utilize low-voltage differential signaling pairs to create a linear array of sensor nodes for each streamer.

As shown, in this exemplary implementation, each node of the sensor array has four cable interfaces. Each node has two receiving cable interfaces (RX pairs) and two transmitting cable interfaces (TX pairs). A cable, such as a twisted-pair cable, may communicate data from a TX pair interface on one node to an RX pair interface on an adjacent node.

As shown, an interface array at the onboard acquisition system may include multiple TX pair and RX pair interfaces, one for each streamer. The TX pair interface of the interface array transmits data to the RX pair interface of a first node (Node 1) of each streamer. The RX pair interface of the interface array receives data from the TX pair interface of a first node (Node 1) of each streamer.

In an exemplary implementation, the data signal may be transmitted using Differential Manchester encoding. Higher-level protocols, including multiplexing, may be encoded over the Differential Manchester encoding.

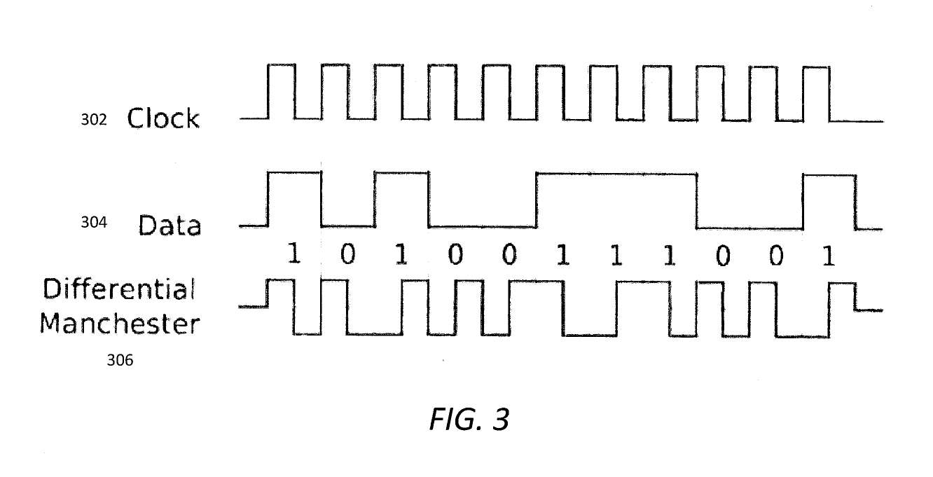

FIG. 3 illustrates a clock signal 302, a data signal 304, and Differential Manchester encoding 306 of the data signal. In an embodiment of the present invention, Differential Manchester encoding may be used for encoding in the low-power synchronous serial interface. Differential Manchester encoding provides a high number of state transitions. For example, a state transition may occur at least once every bit. The high number of state transitions may improve clock recovery and synchronization.

Note that the Differential Manchester waveform depicted in FIG. 3 is generated using an HDL (hardware description language) simulation. The resulting Differential Manchester waveform 306 expresses the presence or absence of a state transition. The beginning and end states of the Differential Manchester waveform 306 are artifacts that represent an indeterminate condition, such as when no previous state transition is known.

Advantageously, the Differential Manchester encoding provides a highest number of transitions on the transmission line for the clock frequency that is used. The higher the number of state transitions in the data signal, the higher the resolution and accuracy which may be obtained at the receiving end. This is because the clock recovery at the receiver uses a phase detector to adjust the phase lock, and phase lock may only be determined upon each state transition. For example, without Differential Manchester encoding, a transmitter may send zeroes (or ones) for a long period of time. There would be no transitions during that period of time, and so the receiver would not be able to measure phase lock accuracy, resulting in the receiver losing phase lock. Such a problematic scenario is avoided because the Differential Manchester encoding provides a state transition for every clock cycle, even when sending only zeroes (or only ones), thus providing a maximum number of state transitions for a give clock frequency.

The Differential Manchester encoding 306 may be direct current (DC) balanced, which may be necessary for alternating current (AC) coupling. A drawback may be a doubling of the clock frequency; however, this may not be an issue because of the high data rates supported by LVDS. Sensor arrays would need to have an overall data rate that is lower than the data rates supported by LVDS. In an exemplary implementation, data rates of 8 megabits per second and 16 bits per second have been tested using Differential Manchester encoding and LVDS.

In at least one embodiment, the low-power synchronous serial interface may be a Phase-Locked-Loop (PLL) system. Such a PLL system may lock the clock frequency of the receiving device with the clock frequency of the transmitting device. The device (i.e. the TX pair interface) that transmits the data stream may encode its clock into the data stream signal. The data stream signal may be Differential Manchester encoded, for example. The device (i.e. the RX pair interface) that receives the data stream may recover the clock and the data from the data stream. The receiving device may perform a phase comparison. The phase error from the phase comparison may be input to a low-pass filter that conditions a control signal for a voltage controlled oscillator (VCXO), thus achieving the phase-locked loop clock recovery.

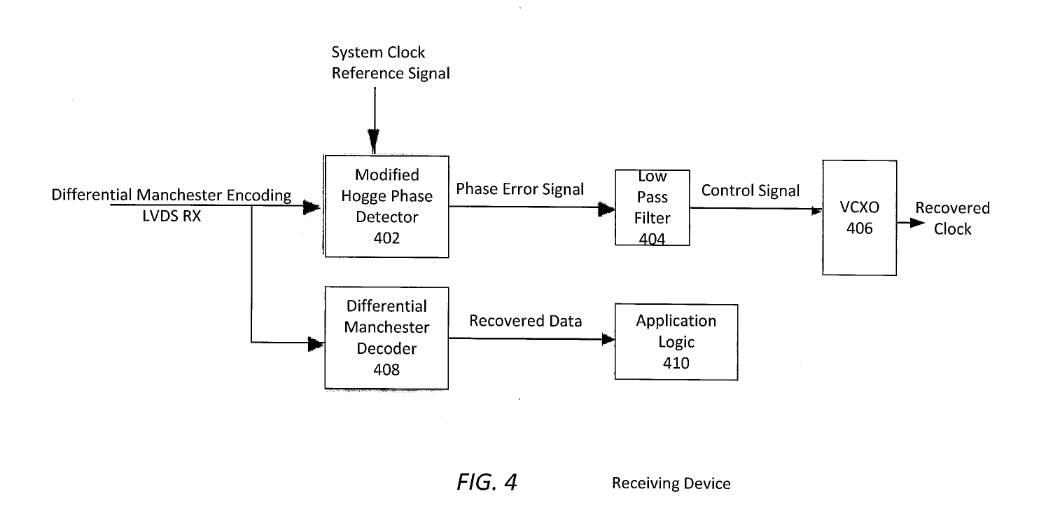

FIG. 4 illustrates a low-power synchronous serial interface for a receiving device that performs clock and data recovery for any receiving pair interface (RX pair) in accordance with an embodiment of the invention. As shown, the low-power synchronous serial interface may receive an LVDS signal that is Differential Manchester encoded.

The circuit structure disclosed herein has been proven to be effective for seismic telemetry at a lower frequency, although it may not be suitable for other applications, such as telecommunications. The effectiveness of the circuit structure for seismic telemetry at a lower frequency is demonstrated by its noise immunity over short distances, despite using an inexpensive transmission medium in an environment that is not optimal. Typically, the sensor arrays have a short distance between numerous nodes; this requires minimum power consumption. LVDS is not typically used over cabling between nodes for seismic telemetry. However, applicant has successfully tested configurations at up to 12 meters separation between nodes.

In contrast, other applications, such as telecommunications, often require higher frequencies and long separations between network nodes. As such, the disclosed solution using Differential Manchester encoding and LVDS would not generally be suitable for these other applications.

Clock recovery may be performed using a modified Hogge phase detector circuit 402, and a phase error low-pass filter 404, and a voltage controlled oscillator (VCXO) circuit 406. The modified Hogge phase detector circuit receives the LVDS signal and the system clock as a reference signal. The modified Hogge phase detector circuit outputs a phase error signal to the low-pass filter which generates the control signal for the VCXO circuit. The VCXO circuit outputs the recovered clock signal.

Data recovery may be performed using a Differential Manchester decoder circuit 408. The Differential Manchester decoder circuit receives the LVDS signal and outputs recovered data signal to application logic 410.

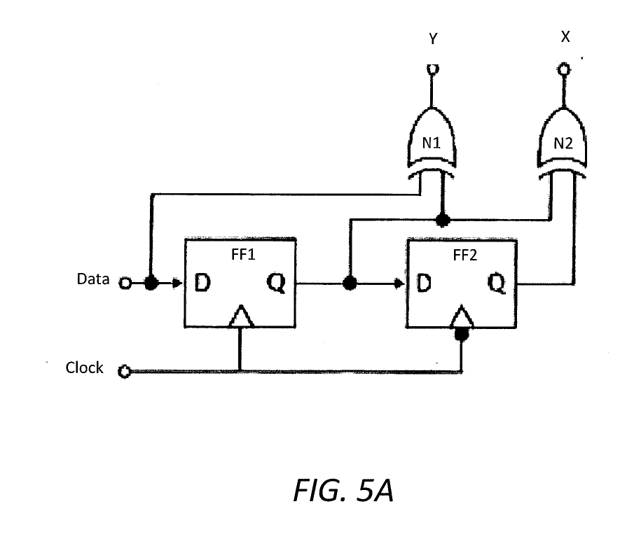

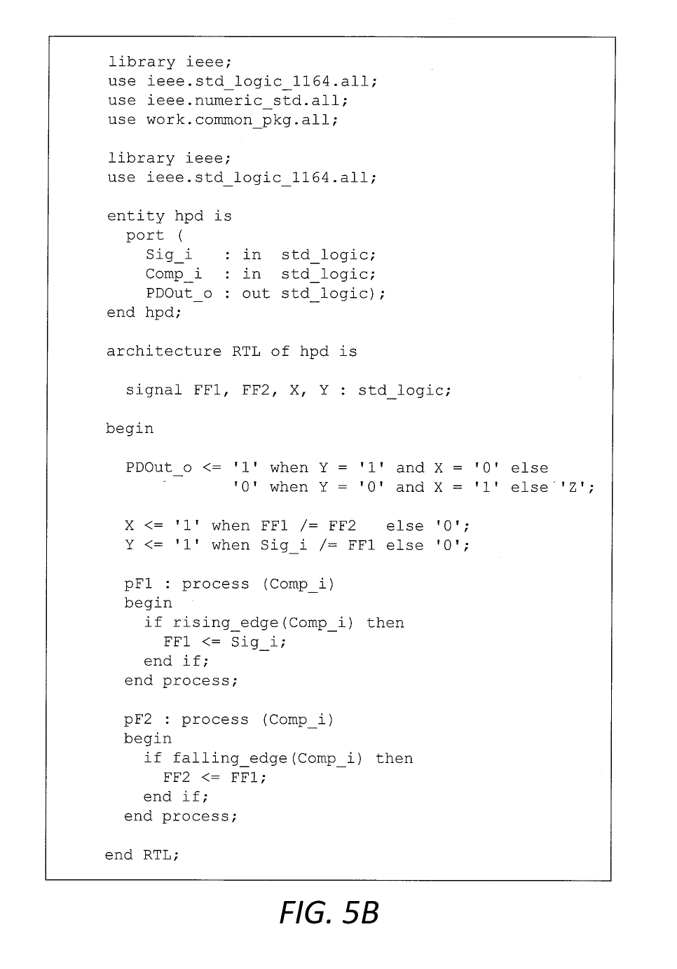

FIG. 5A illustrates an exemplary implementation of a Hogge phase detector circuit. As shown, Data and Clock signals are received by a series of two flip-flop circuits (FF1 and FF2) of the Hogge phase detector circuit. A first logic circuit (N1) receives the received Data signal at one input, the data signal from the data output (B) of FF1 at another input, and outputs the Y signal. A second logic circuit (N2) receives the data signal from the data output (B) of FF1 at one input, the data signal from the output node (A) of FF2 at another input, and outputs the X signal. In the exemplary implementation shown, N1 and N2 are each an exclusive- or (XOR) gate.

As shown in FIG. 5A, Data and Clock signals are received by a series of two flip-flop circuits (FF1 and FF2) of the modified Hogge phase detector circuit. A first logic circuit (N1) receives the received Data signal at one input, the data signal from the data output (B) of FF1 at another input, and outputs the Y signal. A second logic circuit (N1) receives the data signal from the data output (B) of FF1 at one input, the data signal from the output node (A) of FF2 at another input, and outputs the X signal. A low-power synchronous serial interface as described herein has shown adequate synchronization and jitter performance for sensor arrays as long as thirty-two nodes with three-meter spacing between the nodes. Spacing of nodes of the sensor array has been tested as long as twelve meters without issue. Signal integrity and quality have also been verified in testing.

Performing phase detection on Differential Manchester encoding may be difficult due to the timing of the state transitions. However, a Hogge phase detector circuit may be modified to perform phase detection on Differential Manchester encoding. In one implementation, the modified Hogge phase detector circuit may be synthesized into a field-programmable gate array (FPGA).

Applicant has designed a modified Hogge phase detector circuit using HDL and then synthesized the modified Hogge phase detector circuit into a programmable logic device (which may be a field programmable gate array or FPGA, for example). In an exemplary implementation disclosed herein, the modified Hogge phase detector circuit is a Hogge phase detector circuit with a tri-stated output.

FIG. 5B shows the modified Hogge phase detector circuit as described using HDL before synthesis in accordance with an embodiment of the invention. The HDL code shows that when Y is a logical 1 and X is a logical 0, then the output signal (PDOut_o) is a logical 1. Otherwise, when Y is a logical 0 and X is a logical 1, then the output signal is a logical 0. Otherwise, when X and Y are both logical 0 or both logical 1, then the output signal is Z, which is a high-impedance steady state.

The high-impedance steady state is output during phase lock. Such a high-impedance state is a third (steady) state for the output signal which is not provided by a standard Hogge phase detector. In contrast, the standard Hogge phase detector has only two states for the output signal. In the standard Hogge phase detector, the output signal is logical 1 or 0 in response to a leading or lagging phase detection; there is no steady state for the output signal.

Further in an exemplary implementation, the low-power asynchronous serial interface may use low-voltage differential signaling (LVDS) as a line driver. The low-power synchronous serial interface may include a two-state voltage encoder.

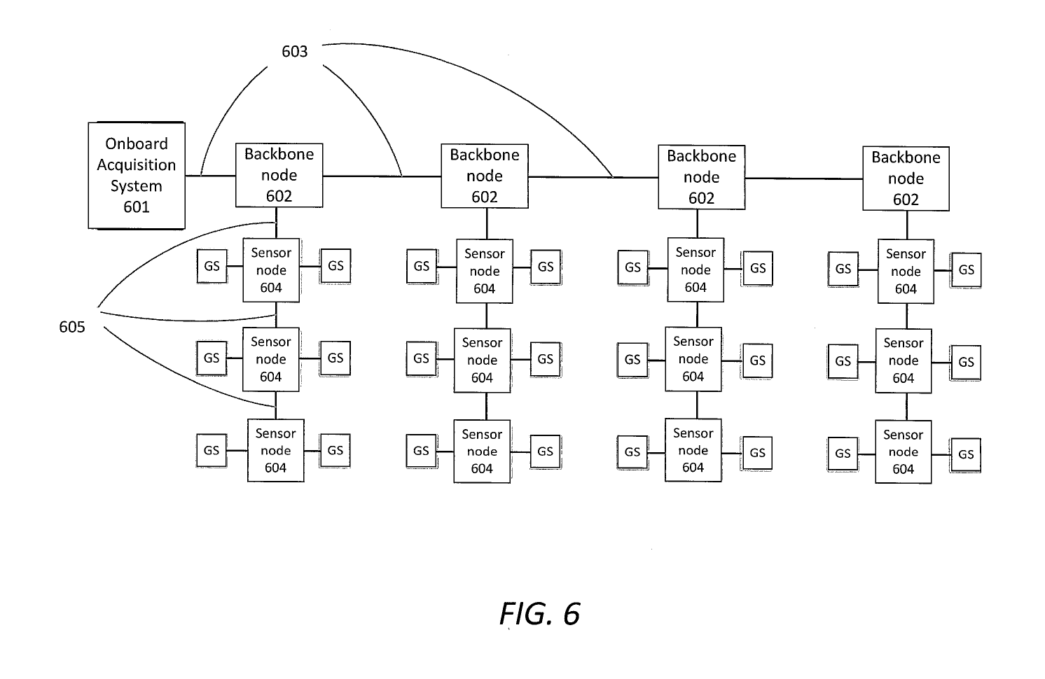

FIG. 6 illustrates telemetry for a geophysical sensor array having a multi-tier network structure in accordance with an embodiment of the invention. In contrast, the sensor array depicted in FIG. 2 has a single-tier network structure.

In FIG. 6, the onboard acquisition system 601 (i.e. the recording system 12 in FIG. 1) is shown as being communicatively coupled to a single streamer having a series of backbone nodes 602. While one streamer is shown for ease of illustration, multiple streamers (each having a series of backbone nodes 602) may be communicatively coupled to the onboard acquisition system 601. The backbone nodes 602 may communicate with each other and with the onboard acquisition system 601 by way of a backbone network 603. In exemplary implementation, the backbone network 603 may utilize an Ethernet protocol between Ethernet nodes.

Each backbone node 602 may be communicatively coupled to a series of sensor nodes 604. Each sensor node 604 may be obtain sensor data from one or more geophysical sensors (GS).

Each backbone node 602 and its associated sensor nodes 604 form a section of the network structure. The communicative connections 605 in each section may be implemented using the low-power synchronous interface disclosed herein. In other words, each sensor node 604 includes the RX and TX interface pairs for communicating data with adjacent nodes as described above in relation to FIG. 2.

Conclusion

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A geophysical sensor array comprising:
one or more towed streamers that are communicatively connected to an onboard acquisition system; and
an array of sensor nodes towed using said one or more streamers,
wherein each sensor node includes at least a first transmitter interface that sends a first transmitted data signal to a first adjacent node and at least a first receiver interface that receives a first received data signal from the first adjacent node, and
wherein the data signals communicated between said interfaces use low-voltage differential signaling and are differential Manchester encoded.

2. The geophysical sensor array of claim 1, wherein each sensor node further includes a second transmitter interface that sends a second transmitted data signal to a second adjacent node and a second receiver interface that receives a second received data signal from the second adjacent node.

3. The geophysical sensor array of claim 1, wherein the first receiver interface comprises a modified Hogge phase detector that receives the first received data signal and a system clock reference signal and outputs a phase error signal, wherein the modified Hogge phase detector generates a tri-stated output.

4. The geophysical sensor array of claim 3, wherein the first receiver interface further comprises a low-pass filter and a voltage controlled oscillator circuit, and wherein the low-pass filter receives the phase error signal and outputs a control signal to the voltage controlled oscillator circuit.

5. The geophysical sensor array of claim 3, wherein the tri-stated output of the modified Hogge phase detector includes a high-impedance output state.

6. The geophysical sensor array of claim 1, wherein the sensor array has a multiple tier network structure.

7. The geophysical sensor array of claim 6, wherein the multiple tier network structure comprises a plurality of backbone nodes, and wherein each backbone node connects to a series of the sensor nodes of the array.

8. An apparatus for seismic data acquisition using a geophysical sensor array, the apparatus comprising:
an onboard acquisition system; and
a plurality of towed streamers that are communicatively connected to the onboard acquisition system and tow an array of sensor nodes;
wherein each sensor node includes at least a first transmitter interface that sends a first transmitted data signal to a first adjacent node and at least a first receiver means that receives a first received data signal from the first adjacent node, and
wherein the data signals communicated between said interfaces use low-voltage differential signaling and are differential Manchester encoded.

9. The apparatus of claim 8, wherein each sensor node further includes a second transmitter interface that sends a second transmitted data signal to a second adjacent node and a second receiver means that receives a second received data signal from the second adjacent node.

10. The apparatus of claim 8, wherein the first receiver means comprises a modified Hogge phase detector that receives the first received data signal and a system clock reference signal and outputs a phase error signal, wherein the modified Hogge phase detector generates a tri-stated output.

11. The apparatus of claim 10, wherein the first receiver means further comprises a low-pass filter and a voltage controlled oscillator circuit, and wherein the low-pass filter receives the phase error signal and outputs a control signal to the voltage controlled oscillator circuit.

12. The apparatus of claim 10, wherein the tri-stated output of the modified Hogge phase detector includes a high-impedance output state.

13. The apparatus of claim 8, wherein the sensor array has a multiple tier network structure.

14. The apparatus of claim 13, wherein the multiple tier network structure comprises a plurality of backbone nodes, and wherein each backbone node connects to a series of the sensor nodes of the array.

15. A method of acquiring marine geophysical data, the method comprising:
towing an array of sensor nodes distributed on one or more streamers; and
each sensor node in the array transmitting data signals to adjacent sensor nodes and receiving data signals from adjacent sensor nodes,
wherein the data signals communicated between said interfaces use low-voltage differential signaling and are differential Manchester encoded.

16. The method of claim 15 further comprising:
a first sensor node in the array transmitting data signals to a receiver interface at the onboard acquisition system and receiving data signals from a transmitter interface at the onboard acquisition system.

17. The method of claim 15, wherein each sensor node includes a receiver interface that comprises a modified Hogge phase detector that generates a tri-stated output signal

18. The method of claim 17, wherein the first receiver interface further comprises a low-pass filter and a voltage controlled oscillator circuit, and wherein the low-pass filter receives the phase error signal and outputs a control signal to the voltage controlled oscillator circuit.

19. The method of claim 15, wherein the sensor array has a multiple tier network structure.

20. The method of claim 19, wherein the multiple tier network structure comprises a plurality of backbone nodes, and wherein each backbone node connects to a series of the sensor nodes of the array.
